(19) United States
(12) Patent Application Publication
(10) Pub. No.: US 2015/0326708 A1
(43) Pub. Date: Nov. 12, 2015

(54) SYSTEM FOR WIRELESS NETWORK MESSAGING USING EMOTICONS

(71) Applicant: Gennis Corporation, Edgewater, NJ (US)

(72) Inventor: Maxim Ginzburg, Moscow (RU)

(21) Appl. No.: 14/667,713

(22) Filed: Mar. 25, 2015

(30) Foreign Application Priority Data
May 8, 2014 (RU) 2014118550

(51) Int. Cl. H04M 1/725; G06F 3/0484; H04L 12/58

(52) U.S. Cl. CPC H04M 1/72552; H04L 51/10; G06F 3/04842

(57) ABSTRACT

A system for messaging, which comprises mobile computing devices of different users connected to each other in a network with each mobile device having a text input unit. The system also comprises a multimedia object storage and selection units. Multimedia objects are associated with tags describing informational content of the message and user's perception of a multimedia object, while the graphic subsystem of the mobile device is able to display such objects based on tags associated with the user input, and the interface of the mobile device enables the user to select at least one of the objects listed, wherein the sender's mobile device is able to send multimedia to the recipient in case the sender places a command to send a multimedia object.

### CROSS-REFERENCE TO RELATED APPLICATIONS

This application claims priority to Russian Patent Application No. 2014118550, filed on May 8, 2014, which is incorporated herein in its entirety.

### BACKGROUND OF THE INVENTION

1. Field of the Invention

The present invention relates to network technologies and can be used in both instant messaging services (i.e., “messengers”) and other systems, which require high levels of interference and noise resistance and preferably use graphics instead of verbal means in communication. In particular, the invention can be used in social networks, mobile networks (e.g., as a part of provided services) and other communication products as well. Also, the invention can be used for automatic choice of multimedia content when creating a website.

2. Description of the Related Art

There are conventional systems on the market, such as Instagram and other image exchange services, by means of which the users form Internet communities or share impressions with each other using their own messages. Since each user selects and/or create messages himself, valuable exchange of information and emotions may be hindered by various cultural, age-specific and other differences, as well as technological imperfections, which may also cause mutual misunderstanding.

Therefore, it is desired to improve image exchange services for more precise transmission of information supplemented with non-verbal objects.

### SUMMARY OF THE INVENTION

The system is intended to create a new search engine, which is able to select images for texts of any length by analyzing (optionally with help from the user) the extended content, meaning and emotional pattern the user implies and/or intends to imply in their texts by attaching a multimedia object.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 illustrates a schematic of an exemplary computer or server that can be used in the system.

FIG. 2 is a generalized drawing of an illustrative embodiment.

FIG. 3 is a diagram of the system structure and request transmission venues, when the user's mobile device communicates with the image database located on a remote server.

FIG. 4 is an exemplary algorithm for the system proposed.

FIG. 5 is an exemplary algorithm for the automatic check of messages to be sent against their compatibility with the receiver.

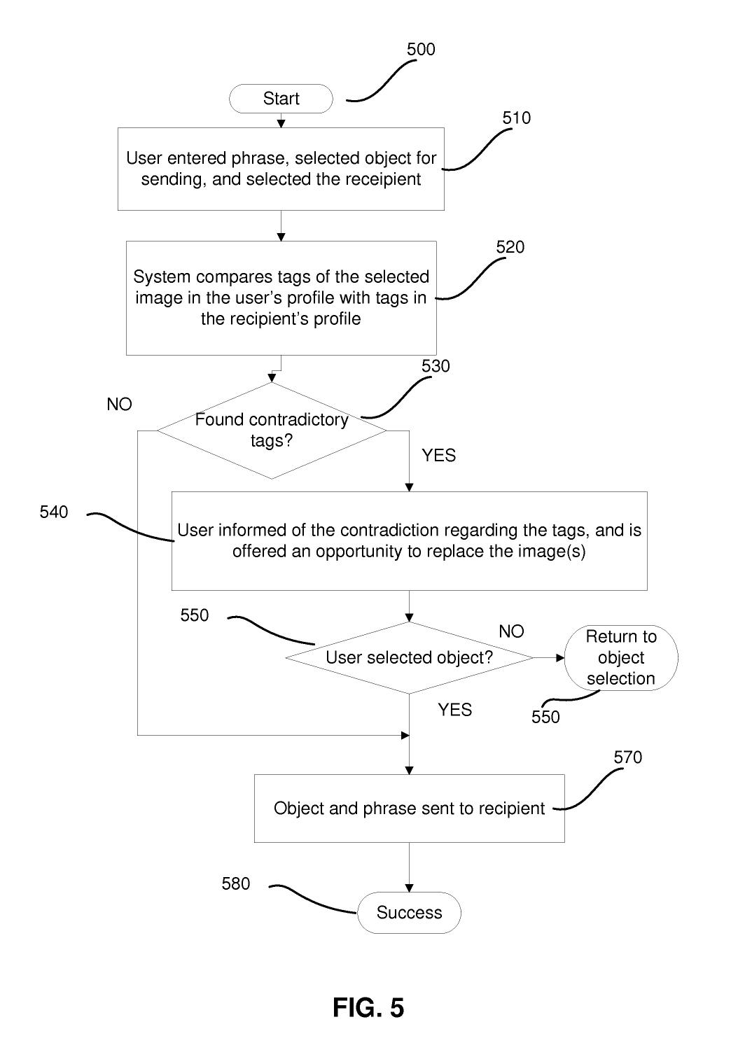

FIG. 6 is an exemplary algorithm for the user's mobile device communicating with an image and messaging server.

FIG. 7 is an exemplary algorithm for the mobile server communicating with an image and messaging server.

FIG. 8A illustrates system operation on the user's device screen (a tablet or a mobile phone with a touch screen).

FIG. 8B illustrates alternative images for “let's play” message.

FIG. 9 is a block diagram of an exemplary mobile device that can be used in the invention.

FIG. 10 is a block diagram of an exemplary implementation of the mobile device.

### DETAILED DESCRIPTION OF THE PREFERRED EMBODIMENTS

Reference will now be made in detail to the preferred embodiments of the present invention, examples of which are illustrated in the accompanying drawings.

The proposed solution to the problem identified above is provided by the fact that the messaging system comprises mobile computing devices of different users connected to each other in a network, with each mobile device having a text input unit and a multimedia object storage unit. The multimedia storage unit stores multimedia objects and parameters associated with them, which describe informational content of and user's perception of each multimedia object. The text input unit of the device also functions as a predictive text recognition unit, which analyzes the user input—both individual words and their context—letter by letter associating them with at least one of the parameters mentioned above.

The graphic subsystem of the mobile device is able to display multimedia objects based on parameters associated with the user himself and the user input, and the interface of the mobile device enables the user to select at least one of the objects listed (either based on the entire text message typed so far, or on a particular word or phrase in the text message, rather than the entire message). Such parameters may include, for example, the sender's age and gender, geolocation data, current time/date, holidays, data from social networks (e.g., the fact that the user participates in soccer-related groups and discussions means that the word “play” may be associated with an image of a soccer ball), user's primary language, occurrence of selection of a particular tag, source of the multimedia object, history of selection of objects by the user, preference tags commonly used by a particular community, any tags derived from automatically processing the image itself, in order to derive its properties, such as its preferred color, texture or presence of some text (possibly, also its language).

A multimedia object can be an image, a quotation, a video or a musical clip and/or their fragments or combinations. In the discussion below, images are frequently used as examples, although the invention is more broadly applicable to different types of multimedia objects.

An exemplary embodiment of the system may comprise an organized database of parameters, where the parameters can be found using fuzzy criteria, while the parameters themselves may be organized in a database of tags. The database may be an object oriented database. The multimedia storage unit may be a network data server, which is connected over communication channels with at least two mobile computing devices of different users, wherein the server is able to store parameter groups associated with multimedia objects, with at least some of them being used by only one user.

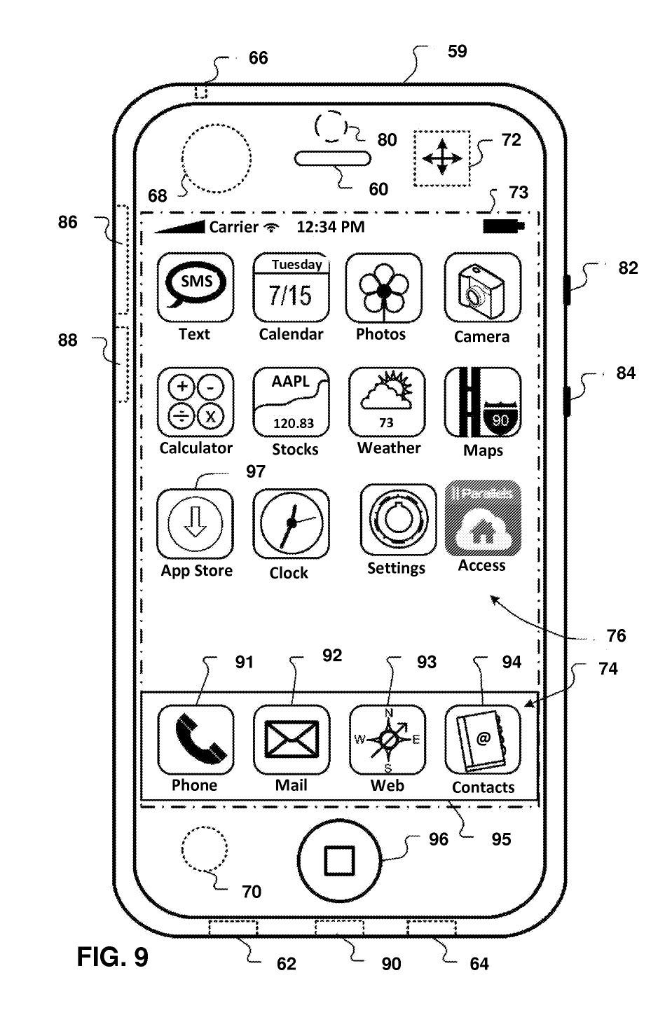

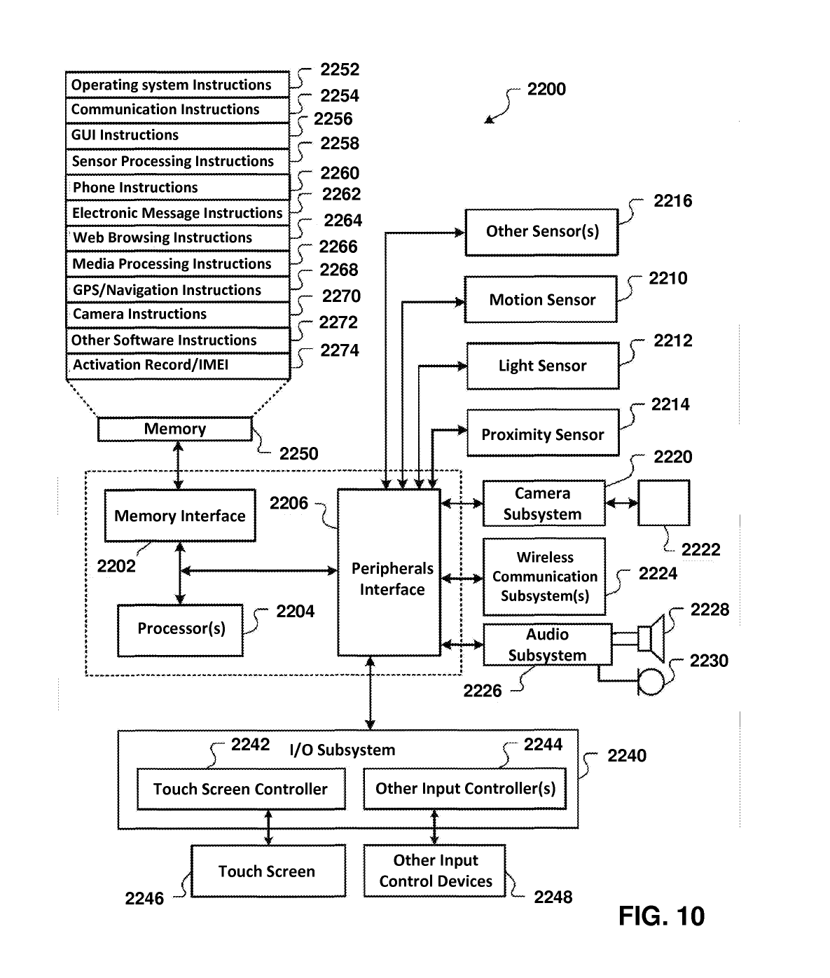

The user's mobile computing device (see FIGS. 9 and 10) may be able to prevent sending messages or warn user before sending messages, if the recipient parameters or settings for a group of similar multimedia objects radically differ from those of the sender. The mobile computing device may also offer the user a possibility to select several multimedia objects and may have a possibility to choose an object from the multimedia storage unit, which corresponds to the majority of tags associated with objects selected before. Each functional unit of the proposed system may be an area of memory of the mobile device, containing CPU control sequences, and execution of functions is initiated by the CPU, which executes the aforementioned sequence, wherein the units communicate with each other using special areas of memory, which are made accessible for the CPU when the CPU executes control instructions corresponding to specific units.

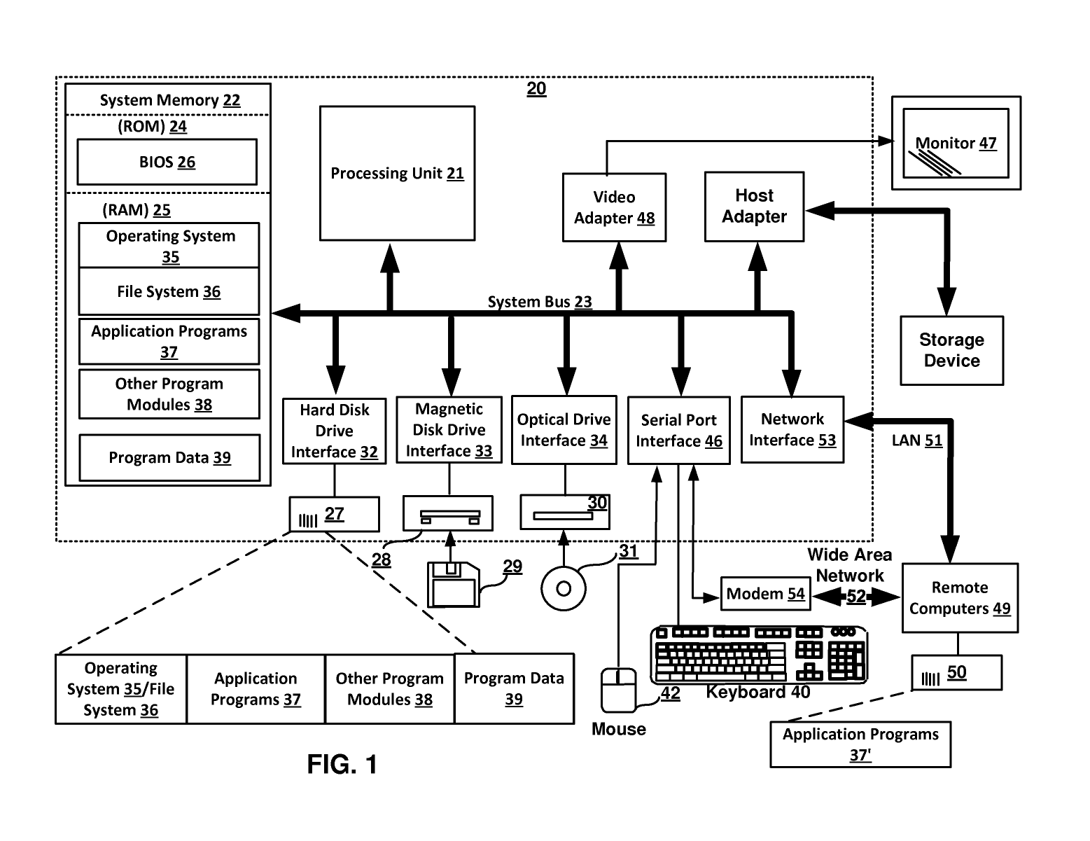

With reference to FIG. 1, an exemplary system for implementing the invention includes a general purpose computing device in the form of any a computer, workstation or a server 20 or the like, including a processing unit 21, a system memory 22, and a system bus 23 that couples various system components including the system memory to the processing unit 21.

The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system 26 (BIOS), containing the basic routines that help transfer information between elements within the computer 20, such as during start-up, is stored in ROM 24.

The computer 20 may further include a hard disk drive 27 or a similar device for data reading from and writing to a hard disk, not shown, a magnetic disk drive 28 for data reading from or writing to a removable magnetic disk 29, and an optical disk drive 30 for data reading from or writing to a removable optical disk 31 such as a CD-ROM, DVD-ROM or other optical media.

The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer readable instructions, data structures, program modules and other data for the computer 20.

Although the exemplary environment described herein employs a hard disk, a removable magnetic disk 29 and a removable optical disk 31, it should be appreciated by those skilled in the art that other types of computer readable media that can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 29, optical disk 31, ROM 24 or RAM 25, including an operating system 35 module. The computer 20 includes a file system 36 associated with or included within the operating system 35, one or more application programs 37, 37′, other program modules 38 and program data 39. A user may enter commands and information into the computer 20 through input devices such as a keyboard 40 and pointing device 42. Other input devices (not shown) may include a microphone, joystick, game pad, satellite dish, scanner or the like.

These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers.

The computer 20 may operate in a networked environment using logical connections to one or more remote computers 49. The remote computer (or computers) 49 may be another computer, a server, a router, a network PC, a peer device or other common network node, and typically includes many or all of the elements described above relative to the computer 20, although only a memory storage device 50 has been illustrated. The logical connections include a local area network (LAN) 51 and a wide area network (WAN) 52. Such networking environments are commonplace in offices, enterprise-wide computer networks, Intranets and the Internet.

When used in a LAN networking environment, the computer 20 is connected to the local network 51 through a network interface or adapter 53. When used in a WAN networking environment, the computer 20 typically includes a modem 54 or other means for establishing communications over the wide area network 52, such as the Internet.

The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used.

In an exemplary embodiment, the data exchange protocol may utilize an API (application program interface) of the network service, to which the invention is connected (e.g., a social network, such as Facebook, Vkontakte, Odnoklassniki, or data exchange service with a high level of protection, such as Skype, Viber, etc., or websites operating in automatic mode).

The mobile device also comprises one or more input units, e.g., a keyboard and/or mouse pointing device, and/or a touch-operated tablet input unit, which may be a screen overlay or a separate module.

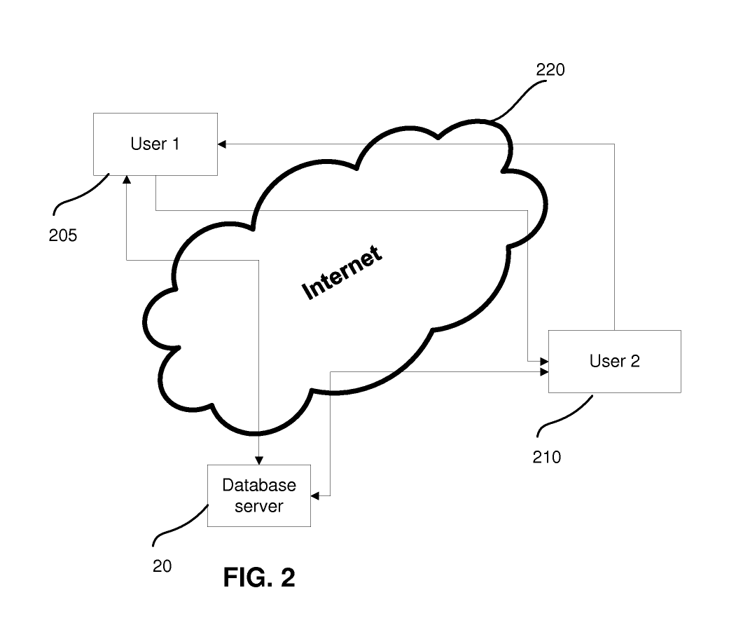

The illustrative embodiment of the system (see FIG. 2) comprises a server 20, which can be used as a means for storing and managing the database containing images and/or other multimedia objects and tags or other descriptors related to multimedia object as well as additional means required for sorting and extracting object from database according to the user's preferences. The multimedia object should be preferably incorporated into users' messages in direct form, and tags, descriptors and other auxiliary information may be used either in hidden or in direct form, for example, to check coincidence between sender and recipient culture or other preferences. Even if the sender had not checked whether or not the recipient can understand the massage properly, the recipient can check the associated tag and get more information of what the sender was trying to express with the message. Other multimedia objects may be videos, musical clips, text fragments or their various combinations. For example, the message may contain an object, which is a book page—real or virtual—with text, and one or several illustrations, such as images and/or videos. As another example, the message may contain a music score with a fragment of an opera and/or a musical clip corresponding to the score.

The system may also interface to one or more users 205, 210, connected to each other via data exchange channels, for instance, the Internet public network 220. The network 220 in question may also be a private local area network (LAN), mobile network, open or private Wi Fi network etc. The users 205, 210 may also be connected to each in a peer-to-peer network or via a dedicated hardware server (e.g., server 20). The server 20 may be implemented as a proxy server or similar.

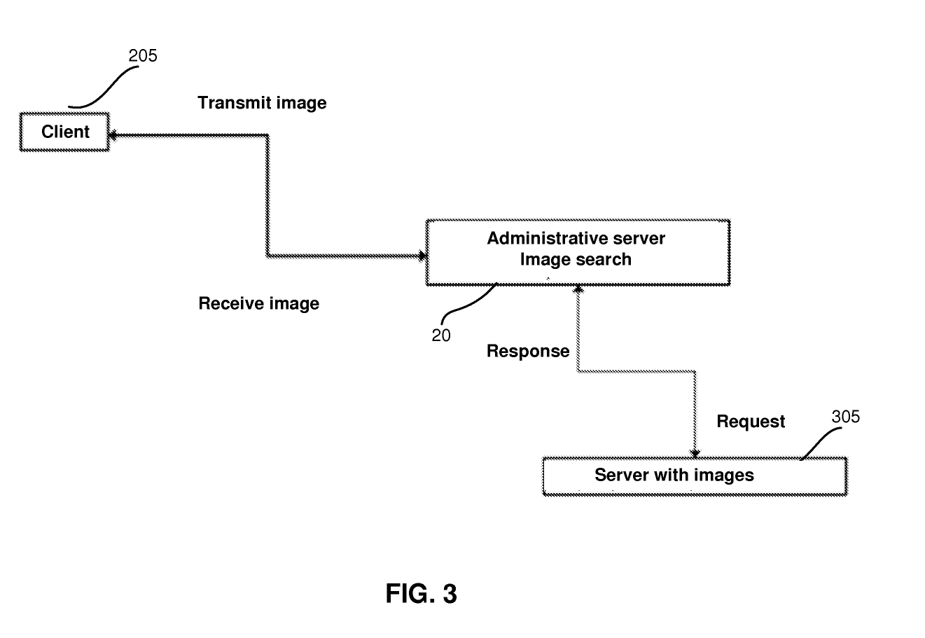

In exemplary embodiment the server 20 may be used as multitasking server, for example, as the database server 20 (see FIG. 3), and simultaneously as a server for receiving messages from the senders, e.g., from the users 205 and 210, and forwarding them to recipients if a direct connection between users is not possible. In this case the messages may be parsed on the server 20 and created and connected by corresponding users over network connection. The system may also employ an extra server 305, designated to store the database contents (e.g., images, tags associated with images, or other aforementioned objects) in digital format. When the user or the client creates a text message, the server 20 processes the message as it appears on screen, then generates and sends requests to the database 305, receives replies to the requests, presents them in a user-friendly fashion and finally sends finished messages to other users, if necessary. As used herein, the term “user” mainly refers to the creator of the message to be sent, and the term “client” mainly refers to the user's device (mobile device), comprising also functional units, specially designed to send and receive messages, and execute supplemental functions.

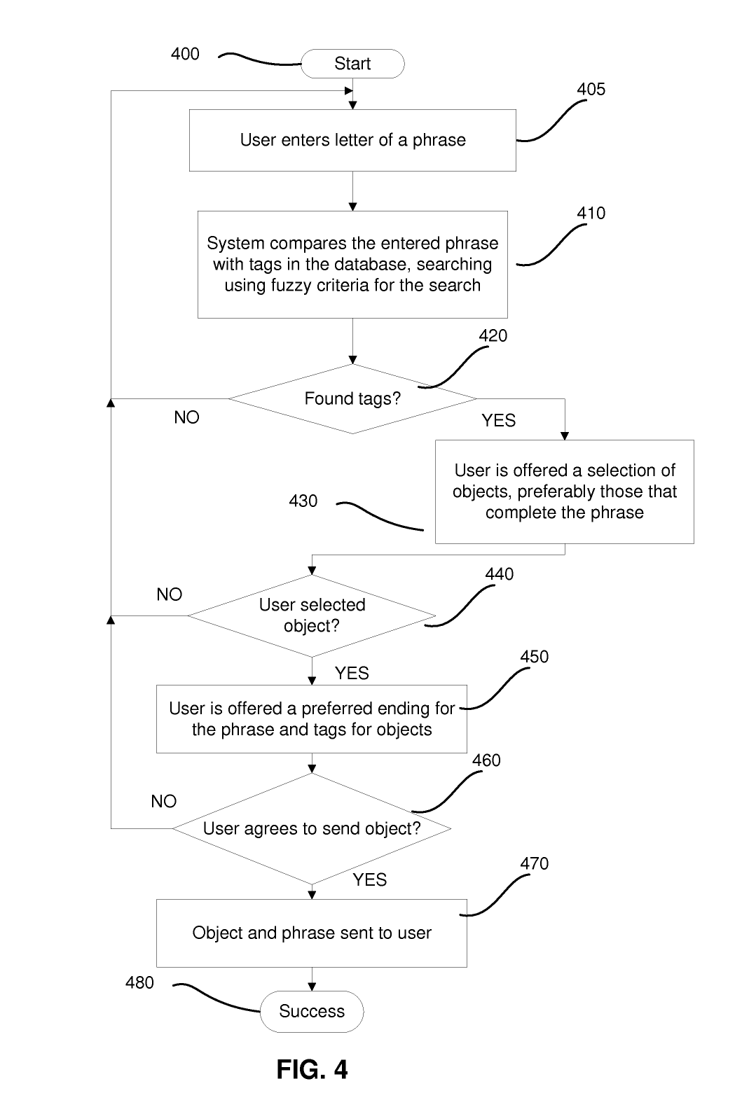

The system works as shown in FIG. 4: after the message input is initiated (step 400), the user starts typing in the characters of the message he intend to send (step 405). The characters may be typed in one at a time, but at the same time an auto-fill/auto-correction system may be used. The input device may be a keyboard with hardware buttons, a virtual keypad on a mobile device screen. Alternative input modes, like voice recognition software to convert voice to text (and then, the system works with the text words and sentence fragments in a similar manner), may be employed as well.

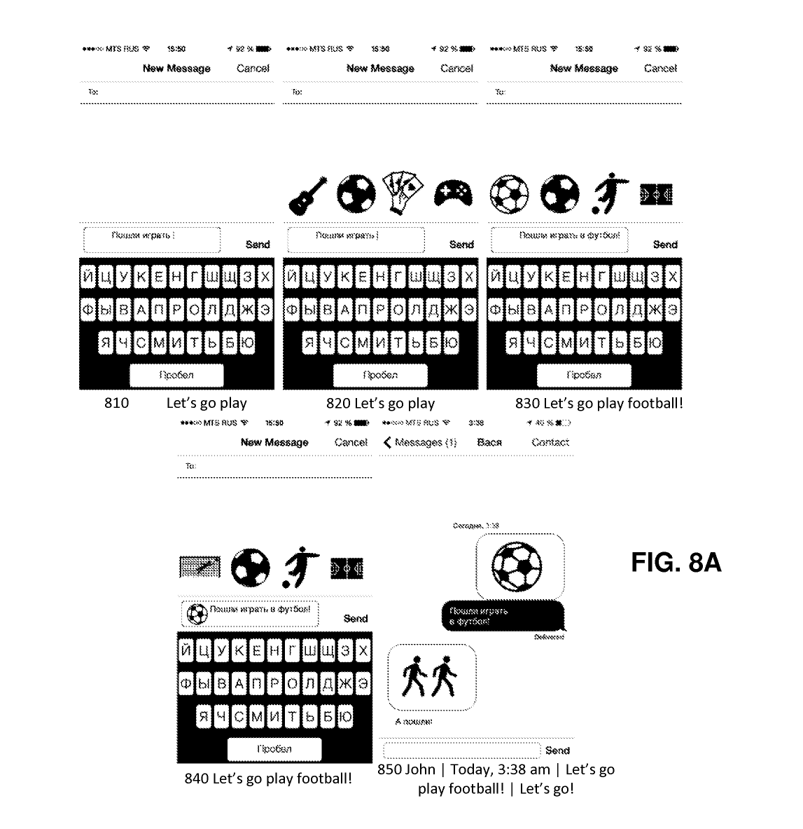

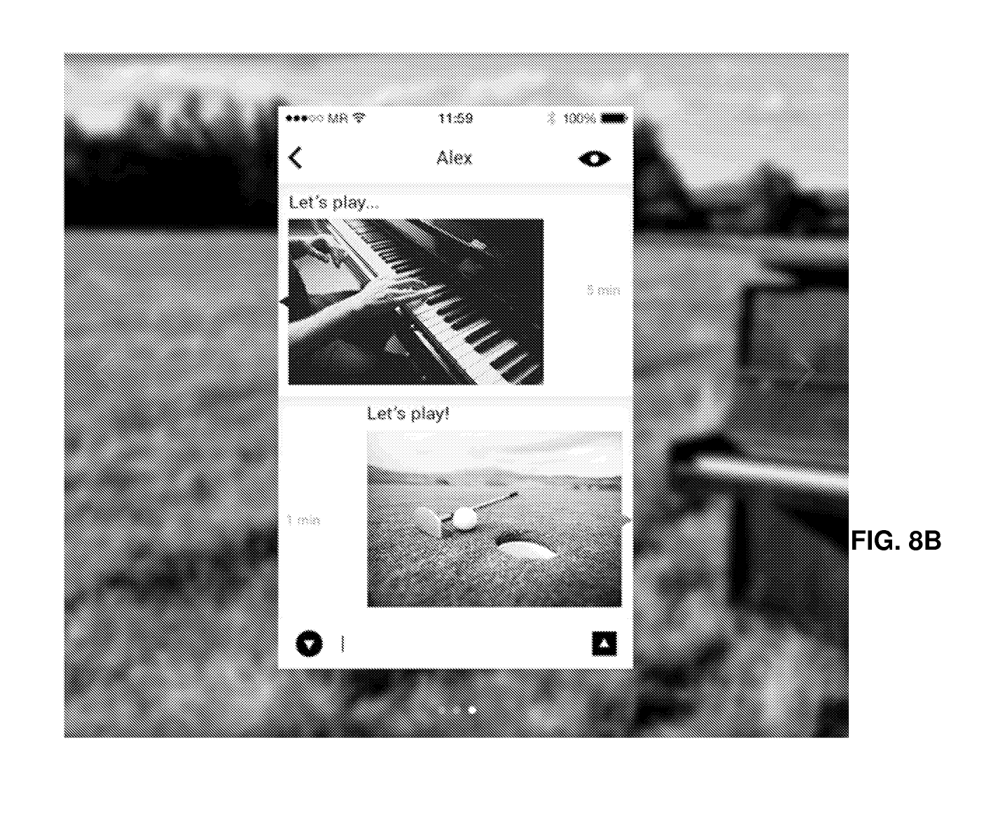

Concurrently with the input process, the system compares the whole message or its completed parts with the database tags using exact, approximate or fuzzy criteria (step 410). In addition or apart from the tags in relational database, the system may also search objects in object-oriented databases. In case there are no tags corresponding to the user's input found at the step 420, the system continues the search process while the message is being typed. The illustration 810 (see FIG. 8A) shows a mobile device screen. Until the message chunk “Let's go play . . . ” is finished, there were too many images with corresponding tags, which is a reason why the system didn't offer any object for the user to select. (see also FIG. 8B showing alternative images.)

If there had been found limited number of images associated with corresponding tags, then the system offers, e.g., by displaying them on the screen (step 430) the images (or other objects) for the user for further specific selection. The illustration 820 (see FIG. 8A) shows that after the message chunk “Let's go play . . . ” has been finalized, the system offers, for selection, images corresponding to various types of activities, including games, sports and videogames.

The images can be ranked according to their relevance to the inputted or in other word printed message. Alternatively, the user preferences related to another user or to a called group of users may be stored in a user's database. During the conversation, the beginning of the phrase being written and the usual user's behavior may be used to form a prompt for the phrase ending and showing the most relevant multimedia objects. If the user does not accept the suggestion and/or objects offered, he continues the input, and the system continues iterative search for actions taking into consideration further changes made in the message.

If the user has selected the object to be sent (step 440) (see 840, FIG. 8A), the system may suggest an appropriate ending for the phrase (step 450), and prompt the user to approve and it send the message with the object attached. If the user agrees with the suggestion (step 460), the message has been sent to the recipient (step 470), and the mobile device is switched into standby mode (see 850, FIG. 8A) until a new message is started (step 480). If the user ignores the prompt, continuing their input, the system will then repeatedly suggest other objects. Note that the selected object stays on screen until another object is selected, if the user so wishes. The illustration 830 (see FIG. 8A) shows that after the phrase “Let's go play football!” has been finished, the system offers the user a range of football-related images, which still differ in their contextual meaning. For instance, some images describe a professional game of football (soccer), other images describe an amateur game, still others describe a leisure time activity.

When working with messages and even with image collections, the user can directly or by mediation means edit the databases by defining a correspondence between multimedia objects and their attributes. The attributes, for example, tags, may be further used, for formal detecting preferable context for using images and finding images or other multimedia objects preferable for context. Here context means the interrelated conditions in which a conversation exists or occurs, and/or environment or settings of the conversation. The words of phrases typed by the user during the conversation may also be filtered if they don't correspond to the context.

The context of the conversation itself may also be set up by user directly and further used for filtering words and multimedia objects.

For example, a lot of conflicts are generated by rough manner of conversation or an aggressive or otherwise inappropriate (or perceived as inappropriate) tone of voice. Here, if the user states that conversation should be calm, the system detects “rough” elements of the conversation, either words or multimedia, and proposes replacements to the user. The receiver has an option to correct tone of voice for each speaker or sender, or for all speakers/senders. Similarly, the sender can select an appropriate tone of voice and correction of tone of voice for each recipient or for all recipients. Another option may be automatic replacement or tone of voice correction.

If the user doesn't agree the image contextual meaning with regard to the current message and doesn't expect it to be used in the future, he can forward it to the Recycle Bin, removing it from the selection offer, e.g., by swiping the fingers up the screen (swipe-up on iPhone) or any other gesture/action, depending on the hardware platform used. The removal is registered in the database, preventing the image from being displayed or prompting to the user who remove the image from usage. In an exemplary embodiment, the user may also be asked, either directly or indirectly, to provide the reasons of the removal (e.g., the user may be offered several Recycle Bins for different reasons, like “wrong meaning” or “general dislike”). It also may help to improve image usage in other conversations or other contexts.

The system also can, if the user wishes, maintain “internal censorship” of messages in order to prevent messages with such an images from being misinterpreted by other users. After the user has approved a message/messages to be sent, the system automatically checks, whether they are agreeable with the receiver (step 500). The system waits until the user finishes inputting, selects an object to be sent (step 510) and chooses the recipient. Before the message is sent, the system compares tags, associated with the object in both the sender's and the recipient's profiles (step 520). If the system fails to find contradicting tags (step 530), it passes on to the step 570, sending the message and the object to the recipient, and then it is switched into standby mode (step 580) until a new message is started.

Otherwise, if there are contradicting tags (step 530), this fact is reported to the user (step 540), and the system the offers some replacement(s), either of the same object type or another. The user may choose a replacement object or keep the original object, in which case the message and the object are sent to the recipient (step 570). Otherwise, if both the replacement and the original object do not satisfy the user, the system is switched into message editing mode (step 550), giving the user an opportunity to continue to edit the message.

In an exemplary embodiment, the user may be provided with a specialized interface, providing a way to select an image from the collection of images (e.g., by marking it). An initial icon or a small copy of the image/object can then be enlarged on the screen by the user action. After that, by clicking on the enlarged icon, the user sends the message with the selected object.

In an exemplary embodiment, when an object is clicked upon for the first time on a process of communication, the system may ask for further instructions during conversation, such as: “send the message after the object is clicked on”; “select the object on click/tap”; “give full information about the object on click/tap” and so on. The same context-sensitive menu may also be triggered on holding the object.

In an exemplary embodiment, the user can set up the icon size and position of icons in a set of objects displayed as icons for further selection or transmission.

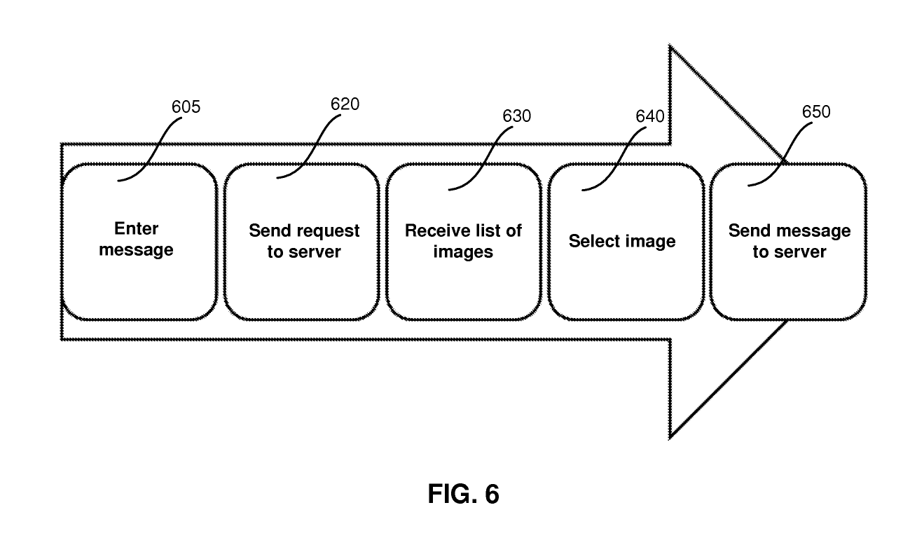

In an exemplary embodiment, all specific user's characteristics (age, sex, language, current geographical location, or a combination of these), which may affect selection or perception of certain images, can be applied automatically upon connection between users. When such characteristics may seriously affect communication effectiveness, the “internal censorship” mechanism preventing sender from sending such problematic messages can be turned on automatically, without a prompt to the user. An approximate algorithm (see FIG. 6) that can be run on the user's mobile device, when there are both an image and a messaging servers, is as follows: the client user types in a phrase or a message chunk (step 605), while the client sends the parts already typed in to the server 20 as a request (step 620), receiving a list of images and/or other objects in response (step 630). After the image or images on the user's choice are selected (step 640), the final text with the image is sent to the server, e.g., as a message (step 650).

In an exemplary embodiment, the user can designate the exact time, either absolute or relative, when the message should be sent from the server to the recipient (e.g., “in an hour” or “on Jun. 2, 2014, 10:31 am”).

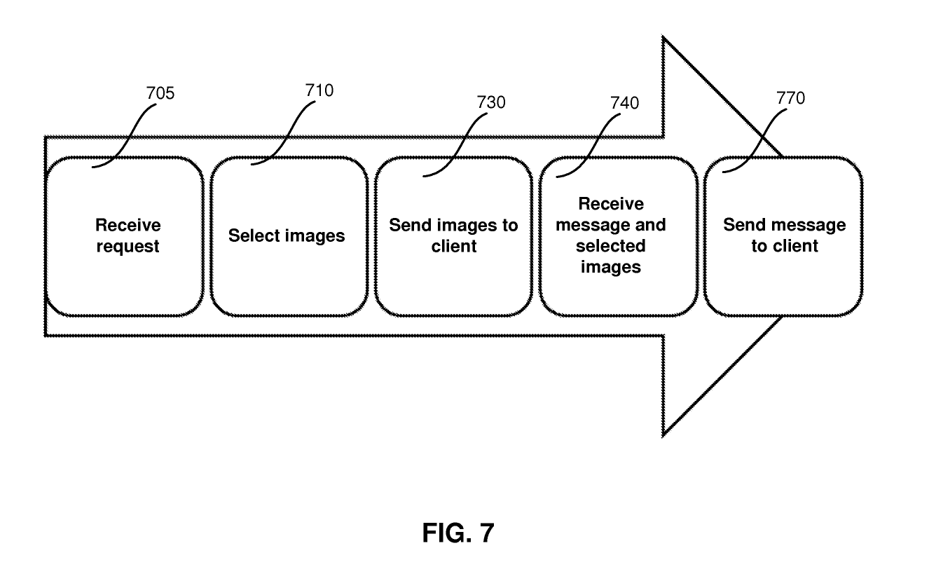

On receiving (step 705) the request 620, the server 20 (see FIG. 7) selects (step 710) some images/objects corresponding to the request and sends (step 730) them or their links to the client, then receives 740 the data 650 and sends (step 770) the message, which has been finalized and approved by the user, to the recipient's mobile device.

Note that all the users may switch the roles of senders and recipients from time to time.

The invention may be used for instant change of messages among users belonging to different language or cultural groups, wherein it provides precise and reliable communication, and makes it possible for the instant messages to be checked by the system immediately to prevent the users from incorrect display of their emotions, so the users can improve their emotional communication techniques.

In an exemplary embodiment, there are created user groups via the Internet, with each group corresponding to a certain cultural or language specification. In each group, there are certain criteria, which may differ from group to group, e.g., mourning color (black or white), mirth color (white or pink), favorite animal (a badger or a crocodile), expression of negation (shaking or nodding one's head), etc. Thus, each group has its unique criteria values, which also may be translated into visual form.

Each user in the group or individual user has a user interface and collection of images associated with the group settings and also with individual user, wherein a part of image collections may be generated according to the aforementioned group-specific criteria, while individual images still retain their own criteria and tags associated with them. Note that the image collection may include images for sending to other users, as well as images that the user does not want to receive, so those images may be blocked. Also, each user may be enabled to define image criteria, as well as add new images to the library by themselves, or add new tags to images, which reflect their personal preferences or communication experience (e.g., if other users have made remarks that the image in question is funny/sad/moving, the user may add such tags to the library). After that, these user-defined tags, when approved by other group members, may also be used to describe the group itself or to include it into wider communities. Also, these tags may be used to draw guidelines on how to communicate with other users most effectively. Note that communication may be both friendly (when interests are shared) and conflict-based (e.g., in case of a philosophical, political or scientific dispute).

During the message exchange, the user may define the preferred image for appearance in certain situations or other properties, e.g., his current location, food and drinks he is consuming, actors from shows, paintings from galleries, etc. Such an image may be selected from the current database, but it also can be created by taking a photo, downloading or even painting or compiling by using a graphic editor. Before the message is sent, the system checks and displays the image properties, which are relevant or irrelevant to the communication. For example, the system may display a tag of specific emotions, which should be evoked in the recipient, or it may hint at possible difference of both users' emotions. Apart from emotions, other hidden properties can be used, thus increasing the image informational content.

For example, the image may contain a high quality picture of a stage set, and scenes from the play may be described, after an automatic or a preliminary analysis, as morose, merry, sentimental, humorous, etc. In an exemplary embodiment, individual image components may have clouds with words or balloons with tags. The tag or cloud provide information on what emotional content these components have and how they combine with other components, whereas connections, however multiple, may be displayed on screen, and a connection group may have a data balloon, containing information on properties of the group and its constituents. In an exemplary embodiment, on user's request, it may be possible to assess the possibility to modify the state of an image part and, if the CPU resources permits, preview modifications as well (in real time). That is, the user can define preferable properties (e.g., romantic moonlit night, heavy rain, quiet morning), and the system, based on pre-programmed data, may add and/or remove some elements, change the color balance of the whole image or its parts.

In an exemplary embodiment, if the system is used by members of different groups with their own cultural and language peculiarities, the users may be given hints telling them that there might be a possibility of mutual misunderstanding, misinterpretation, or lack of informativeness. In this case, or anytime the user selects an image to be sent, the system may suggest alternatives and prevents images from being sent without additional approval.

In an exemplary embodiment, if the user agrees, the system may ask him to rate images and comment on images and tags corresponding to images. Here, the system can get the information about corresponding between user perception and interpretation of the perception by the system. In this case, the system can join users with a similar perception of large number of images in groups, which will facilitate statistics collection and communication in general, as well as simplify communication between users of the group.

In another embodiment of the invention, the unusual perception or tags established for the plurality of users of such a group may be shared with other users of the group if the particular user had never rated the specific image.

In one of the applications, images may accompany the message creation process, wherein the user may be shown different image groups as the typing proceeds. For example, after typing “a young crocodile”, the user may be shown a series of images with crocodiles, but after “looks for friends” is added, images from cartoons and storybooks where crocodiles were looking for friends will have priority. Also, after the message is sent, the recipient may be offered to answer with images of characters from the same cartoon/book, or with derived images processed with a means for changing emotional content. In the exemplary embodiment, the system may suggest appropriate endings to the message, if the text is unfinished, but the image has been selected. Here, a storybook phrase may be used for finalizing the massage.

In confidential communication, users can also choose a topic, which provides a background or a virtual environment for certain characters to talk to each other. The advantage of the present invention is that the messages can still be exchanged, even if the users don't know each other's language or emotional code. In the exemplary embodiment described above, phrase ending suggestions alongside with images facilitates improvement of language skills, body and sign language skills, and emotional understanding skills.

The present invention may be implemented in a network, that may be configured for peer to peer connections. Here the system may provide each user with an image server and an emotion processing server, where each user has his own image sets. Selected and (optionally) processed using additional processing means, images are loaded from corresponding servers and are sent to and from users by their devices. When users have shared servers, images and optionally emotional identification data may be sent between users instead of just images.

In an exemplary embodiment, images belonging to different cultural backgrounds may be displayed on the same screen, providing the user with two options: either choose the recipient-oriented image or try to adapt the message so that it is interpreted in the same way by all sides. Recipient-oriented images are then chosen from a recipient-owned or recipient-oriented database. In an exemplary embodiment, such a function will prevent the user from using figures of speech, which have opposite meanings in different cultures.

The main principle described herein can also be used while working with various digital and analogue objects, and not only static images, for instance, compressed video in various versions of MPEG or FLV format, musical clips, as well as quotations from literary works, including poetry in various forms, such as ruba'i or haiku. In case with musical clips, the user may be presented with the most illustrative fragments, while in case with videos, the user may view a silent fragment or a characteristic quotation.

The user is also able to select multimedia from object groups organized, for instance, according to their author or genre (for music—songs, rock‘n’roll; for video—short sitcom episodes or episode parts; for literature—fairy-tales, novels, sci-fi, etc.).

When using voice communication, multimedia objects are automatically selected and displayed in real time. The objects and the history of the conversation, in multimedia form, can be saved and displayed during and after the conversation. The process works as follows:

Receive voice input;

Convert voice input to text;

Convert text to tags;

Select object(s) based on tags;

Display possible object(s) for user selection;

Select one or more object during or after the conversation.

A user can select the option to see only objects/images, without showing text. Also, the user can select an object from a list of objects presented to him, and the system will automatically display the tags/description of the object. The description/tags can be verbalized using text to speech conversion.

Working with audio objects, such as musical pieces, is more complex, because such an object can rarely be viewed or heard in a short amount of time or by using a short glance at it. For audio and video objects/fragments, a list is generated that is easier for the user to understand. In one example, for musical pieces, a standard definition of tempo can be shown, e.g., from slowest to fastest:
Larghissimo—very, very slow (24 BPM and under)
Grave—very slow (25-45 BPM)
Lento—slowly (45-50 BPM)
Largo—broadly (50-55 BPM)
Larghetto—rather broadly (55-60 BPM)
Adagio—slow and stately (literally, “at ease”) (60-72 BPM)
Adagietto—slower than andante (72-80 BPM)
Andantino—slightly slower than andante (although in some cases it can be taken to mean slightly faster than andante) (80-84 BPM)
Andante—at a walking pace (84-90 BPM)
Andante moderato—between andante and moderato (thus the name andante moderato) (90-96 BPM)
Marcia moderato—moderately, in the manner of a march (83-85 BPM)
Moderato—moderately (96-108 BPM)
Allegro Moderato—moderately fast (108-112 BPM)
Allegretto—close to but not quite allegro (112-120 BPM)
Allegro—fast, quickly, and bright (120-128 BPM) (molto allegro is slightly faster than allegretto, but always in its range)
Vivace—lively and fast (132-144 BPM)
Vivacissimo—very fast and lively (144-160 BPM)
Allegrissimo (or Allegro Vivace)—very fast (145-167 BPM)
Presto—extremely fast (168-200 BPM)
Prestissimo—even faster than Presto (200 BPM and over)
   Terms for tempo change:
Ritardando or rallentando—gradually slowing down
Accelerando or stringendo—gradually accelerating
   Mood markings with a tempo connotation can be used—some markings that primarily mark a mood (or character) also have a tempo connotation:
Affettuoso—with feeling/emotion
Agitato—agitated, with implied quickness
Appassionato—to play passionately
Animato—animatedly, lively
Brillante—sparkling, glittering, as in Allegro brillante, Rondo brillante, or

Variations brillantes; became fashionable in titles for virtuoso pieces
Bravura—broadly
Cantabile—in singing style (lyrical and flowing)
Calando—dying away, slowing, diminishing
Dolce—sweetly
Dolcissimo—very sweetly and delicately
Energico—energetic, strong, forceful
Eroico—heroically
Espressivo—expressively
Furioso—to play in an angry or furious manner
Giocoso—merrily, funny
Gioioso—joyfully
Grandioso—magnificently, grandly
Grazioso—gracefully
Incalzando—encouraging, building
Lacrimoso—tearfully, sadly
Lamentoso—lamenting, mournfully
Leggiero—to play lightly, or with light touch
Leggiadro—lightly and gracefully
Maestoso—majestic or stately (which generally indicates a solemn, slow march-like movement)
Malinconico—melancholic
Marcato—marching tempo, marked with emphasis
Marziale—in a march style, usually in simple, strongly marked rhythm and regular phrases
Mesto—sad, mournful
Misterioso—mystical, in a shady manner
Morendo—dying
Nobilmente—nobly (in a noble way)
Patetico—with great emotion
Pesante—heavily
Saltando—jumpy, fast, and short
Scherzando—playfully
Smorzando—dying away, decreasing to nothing in both speed and dynamic
Sostenuto—sustained, with a slowing of tempo
Spiccato—slow sautillé, with a bouncy manner
Tenerezza—tenderness
Tranquillamente—adverb of tranquillo, “calmly”
Trionfante—triumphantly
Vivace—lively and fast, over 140 BPM (which generally indicates a fast movement)

In one example, the tempo is determined by how the user uses the keyboard, how he speaks, etc., and a corresponding musical piece is selected (e.g., a user who speaks slowly and uses the keyboard slowly is offered musical pieces in the andante moderato tempo, and so on. Similarly, depending on changes in the user's speech pattern (speed, tembre, etc.), musical pieces with corresponding changes (e.g., slowing down or speeding up) can be selected.

Additionally, keywords in the message can be used to select the appropriate musical fragment, e.g., changing the tempo, the volume, which can correspond to a change in the time of day, weather, etc.

In one embodiment, the user can be offered fragments of music sheets, together with the tags or used as tags. The user can be offered specific composers or musical groups from selected musical pieces or video fragments, specific arrangements of the music/videos, and other similar information, while the music or video fragment itself can be initially provided in a more general descriptive form (or a short 1-2 second segment that would be recognizable to the user). The user can then select the words or symbols that will definitively identify the music/video fragment or other similar multimedia objects.

A particular word, used in the context of a conversation, can have different correspondence to different multimedia objects. For example, “end of talk” or @end of talk” can correspond to a gesture of a referee, if the participants are soccer fans, or a different gesture if the participants are Boy Scouts, etc.

Also, the musical fragment by one performer can be replaced by the same music performed by another performed, if it is known that the second performer is preferred, for that particular user (sender and/or recipient). As another example, the sender can send the object “as is”, if he believes that the “as is” form is preferable or should not be altered.

In one embodiment, the sender or caller might not have a connection to the recipient, for example, when the call connection is not yet completed, or when a search for the recipient network specific connection ID (for example cellular station-dependent ID) is initiated in a distributed network, or while the sender is waiting for response from the recipient when the connection is established. In that case, the sender is provided with a communication interface as if connection is already established. The sender can start composing the message from the moment the call is initiated or the recipient is selected.

Thus, the user can define the subject of the conversation, can select objects while waiting for the call to connect and is able to edit the message that is being prepared for sending. Then, when connection is established the recipient specific data is loaded or taken into consideration on the sender's mobile device, and if the data affects the communication settings, for example, stop words or forbidden images, the sender is informed and the message is blocked from being sent without sender's additional approval.

The concept may also be improved by other options, for example, if the user finds a proposed picture along with utilized phrases worth memorizing, he can use an option of using a screenshot. Another option may be a delayed conversation when the user compiles the massage and establishes the message sending or receiving time, for example, receiving a message on somebody's birthday's morning.

FIG. 10 is a block diagram of an exemplary mobile device 59 on which the invention can be implemented. The mobile device 59 can be, for example, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

In some implementations, the mobile device 59 includes a touch-sensitive display 73. The touch-sensitive display 73 can implement liquid crystal display (LCD) technology, light emitting polymer display (LPD) technology, or some other display technology. The touch-sensitive display 73 can be sensitive to haptic and/or tactile contact with a user.

In some implementations, the touch-sensitive display 73 can comprise a multi-touch-sensitive display 73. A multi-touch-sensitive display 73 can, for example, process multiple simultaneous touch points, including processing data related to the pressure, degree and/or position of each touch point. Such processing facilitates gestures and interactions with multiple fingers, chording, and other interactions. Other touch-sensitive display technologies can also be used, e.g., a display in which contact is made using a stylus or other pointing device.

In some implementations, the mobile device 59 can display one or more graphical user interfaces on the touch-sensitive display 73 for providing the user access to various system objects and for conveying information to the user. In some implementations, the graphical user interface can include one or more display objects 74, 76. In the example shown, the display objects 74, 76, are graphic representations of system objects. Some examples of system objects include device functions, applications, windows, files, alerts, events, or other identifiable system objects.

In some implementations, the mobile device 59 can implement multiple device functionalities, such as a telephony device, as indicated by a phone object 91; an e-mail device, as indicated by the e-mail object 92; a network data communication device, as indicated by the Web object 93; a Wi-Fi base station device (not shown); and a media processing device, as indicated by the media player object 94. In some implementations, particular display objects 74, e.g., the phone object 91, the e-mail object 92, the Web object 93, and the media player object 94, can be displayed in a menu bar 95. In some implementations, device functionalities can be accessed from a top-level graphical user interface, such as the graphical user interface illustrated in the figure. Touching one of the objects 91, 92, 93 or 94 can, for example, invoke corresponding functionality.

In some implementations, the mobile device 59 can implement network distribution functionality. For example, the functionality can enable the user to take the mobile device 59 and its associated network while traveling. In particular, the mobile device 59 can extend Internet access (e.g., Wi-Fi) to other wireless devices in the vicinity. For example, mobile device 59 can be configured as a base station for one or more devices. As such, mobile device 59 can grant or deny network access to other wireless devices.

In some implementations, upon invocation of device functionality, the graphical user interface of the mobile device 59 changes, or is augmented or replaced with another user interface or user interface elements, to facilitate user access to particular functions associated with the corresponding device functionality. For example, in response to a user touching the phone object 91, the graphical user interface of the touch-sensitive display 73 may present display objects related to various phone functions; likewise, touching of the email object 92 may cause the graphical user interface to present display objects related to various e-mail functions; touching the Web object 93 may cause the graphical user interface to present display objects related to various Web-surfing functions; and touching the media player object 94 may cause the graphical user interface to present display objects related to various media processing functions.

In some implementations, the top-level graphical user interface environment or state can be restored by pressing a button 96 located near the bottom of the mobile device 59. In some implementations, each corresponding device functionality may have corresponding “home” display objects displayed on the touch-sensitive display 73, and the graphical user interface environment can be restored by pressing the “home” display object.

In some implementations, the top-level graphical user interface can include additional display objects 76, such as a short messaging service (SMS) object, a calendar object, a photos object, a camera object, a calculator object, a stocks object, a weather object, a maps object, a notes object, a clock object, an address book object, a settings object, and an app store object 97. Touching the SMS display object can, for example, invoke an SMS messaging environment and supporting functionality; likewise, each selection of a display object can invoke a corresponding object environment and functionality.

Additional and/or different display objects can also be displayed in the graphical user interface. For example, if the device 59 is functioning as a base station for other devices, one or more “connection” objects may appear in the graphical user interface to indicate the connection. In some implementations, the display objects 76 can be configured by a user, e.g., a user may specify which display objects 76 are displayed, and/or may download additional applications or other software that provides other functionalities and corresponding display objects.

In some implementations, the mobile device 59 can include one or more input/output (I/O) devices and/or sensor devices. For example, a speaker 60 and a microphone 62 can be included to facilitate voice-enabled functionalities, such as phone and voice mail functions. In some implementations, an up/down button 84 for volume control of the speaker 60 and the microphone 62 can be included. The mobile device 59 can also include an on/off button 82 for a ring indicator of incoming phone calls. In some implementations, a loud speaker 64 can be included to facilitate hands-free voice functionalities, such as speaker phone functions. An audio jack 66 can also be included for use of headphones and/or a microphone.

In some implementations, a proximity sensor 68 can be included to facilitate the detection of the user positioning the mobile device 59 proximate to the user's ear and, in response, to disengage the touch-sensitive display 73 to prevent accidental function invocations. In some implementations, the touch-sensitive display 73 can be turned off to conserve additional power when the mobile device 59 is proximate to the user's ear.

Other sensors can also be used. For example, in some implementations, an ambient light sensor 70 can be utilized to facilitate adjusting the brightness of the touch-sensitive display 73. In some implementations, an accelerometer 72 can be utilized to detect movement of the mobile device 59, as indicated by the directional arrows. Accordingly, display objects and/or media can be presented according to a detected orientation, e.g., portrait or landscape. In some implementations, the mobile device 59 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS recipient) can be integrated into the mobile device 59 or provided as a separate device that can be coupled to the mobile device 59 through an interface (e.g., port device 90) to provide access to location-based services.

The mobile device 59 can also include a camera lens and sensor 80. In some implementations, the camera lens and sensor 80 can be located on the back surface of the mobile device 59. The camera can capture still images and/or video.

The mobile device 59 can also include one or more wireless communication subsystems, such as an 802.11b/g communication device 86, and/or a BLUETOOTH communication device 88. Other communication protocols can also be supported, including other 802.x communication protocols (e.g., WiMax, Wi-Fi, 3G, LTE), code division multiple access (CDMA), global system for mobile communications (GSM), Enhanced Data GSM Environment (EDGE), etc.

In some implementations, the port device 90, e.g., a Universal Serial Bus (USB) port, or a docking port, or some other wired port connection, is included. The port device 90 can, for example, be utilized to establish a wired connection to other computing devices, such as other communication devices 59, network access devices, a personal computer, a printer, or other processing devices capable of receiving and/or transmitting data. In some implementations, the port device 90 allows the mobile device 59 to synchronize with a host device using one or more protocols, such as, for example, the TCP/IP, HTTP, UDP and any other known protocol. In some implementations, a TCP/IP over USB protocol can be used.

FIG. 11 is a block diagram 2200 of an example implementation of the mobile device 59. The mobile device 59 can include a memory interface 2202, one or more data processors, image processors and/or central processing units 2204, and a peripherals interface 2206. The memory interface 2202, the one or more processors 2204 and/or the peripherals interface 2206 can be separate components or can be integrated in one or more integrated circuits. The various components in the mobile device 59 can be coupled by one or more communication buses or signal lines.

Sensors, devices and subsystems can be coupled to the peripherals interface 2206 to facilitate multiple functionalities. For example, a motion sensor 2210, a light sensor 2212, and a proximity sensor 2214 can be coupled to the peripherals interface 2206 to facilitate the orientation, lighting and proximity functions described above. Other sensors 2216 can also be connected to the peripherals interface 2206, such as a positioning system (e.g., GPS recipient), a temperature sensor, a biometric sensor, or other sensing device, to facilitate related functionalities.

A camera subsystem 2220 and an optical sensor 2222, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 2224, which can include radio frequency recipients and transmitters and/or optical (e.g., infrared) recipients and transmitters. The specific design and implementation of the communication subsystem 2224 can depend on the communication network(s) over which the mobile device 59 is intended to operate. For example, a mobile device 59 may include communication subsystems 2224 designed to operate over a GSM network, a GPRS network, an EDGE network, a Wi-Fi or WiMax network, and a BLUETOOTH network. In particular, the wireless communication subsystems 2224 may include hosting protocols such that the device 59 may be configured as a base station for other wireless devices.

An audio subsystem 2226 can be coupled to a speaker 2228 and a microphone 2230 to facilitate voice-enabled functions, such as voice recognition, voice replication, digital recording, and telephony functions.

The I/O subsystem 2240 can include a touch screen controller 2242 and/or other input controller(s) 2244. The touch-screen controller 2242 can be coupled to a touch screen 2246. The touch screen 2246 and touch screen controller 2242 can, for example, detect contact and movement or break thereof using any of multiple touch sensitivity technologies, including but not limited to capacitive, resistive, infrared, and surface acoustic wave technologies, as well as other proximity sensor arrays or other elements for determining one or more points of contact with the touch screen 2246.

The other input controller(s) 2244 can be coupled to other input/control devices 2248, such as one or more buttons, rocker switches, thumb-wheel, infrared port, USB port, and/or a pointer device such as a stylus. The one or more buttons (not shown) can include an up/down button for volume control of the speaker 2228 and/or the microphone 2230.

In one implementation, a pressing of the button for a first duration may disengage a lock of the touch screen 2246; and a pressing of the button for a second duration that is longer than the first duration may turn power to the mobile device 59 on or off. The user may be able to customize a functionality of one or more of the buttons. The touch screen 2246 can, for example, also be used to implement virtual or soft buttons and/or a keyboard.

In some implementations, the mobile device 59 can present recorded audio and/or video files, such as MP3, AAC, and MPEG files. In some implementations, the mobile device 59 can include the functionality of an MP3 player. The mobile device 59 may, therefore, include a 32-pin connector that is compatible with the MP3 player. Other input/output and control devices can also be used.

The memory interface 2202 can be coupled to memory 2250. The memory 2250 can include high-speed random access memory and/or non-volatile memory, such as one or more magnetic disk storage devices, one or more optical storage devices, and/or flash memory (e.g., NAND, NOR). The memory 2250 can store an operating system 2252, such as Darwin, RTXC, LINUX, UNIX, OS X, ANDROID, IOS, WINDOWS, or an embedded operating system such as VxWorks. The operating system 2252 may include instructions for handling basic system services and for performing hardware dependent tasks. In some implementations, the operating system 2252 can be a kernel (e.g., UNIX kernel).

The memory 2250 may also store communication instructions 2254 to facilitate communicating with one or more additional devices, one or more computers and/or one or more servers. The memory 2250 may include graphical user interface instructions 2256 to facilitate graphic user interface processing including presentation, navigation, and selection within an application store; sensor processing instructions 2258 to facilitate sensor-related processing and functions; phone instructions 2260 to facilitate phone-related processes and functions; electronic messaging instructions 2262 to facilitate electronic-messaging related processes and functions; web browsing instructions 2264 to facilitate web browsing-related processes and functions; media processing instructions 2266 to facilitate media processing-related processes and functions; GPS/Navigation instructions 2268 to facilitate GPS and navigation-related processes and instructions; camera instructions 2270 to facilitate camera-related processes and functions; and/or other software instructions 2272 to facilitate other processes and functions.

Each of the above identified instructions and applications can correspond to a set of instructions for performing one or more functions described above. These instructions need not be implemented as separate software programs, procedures or modules. The memory 2250 can include additional instructions or fewer instructions. Furthermore, various functions of the mobile device 59 may be implemented in hardware and/or in software, including in one or more signal processing and/or application specific integrated circuits.

Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

What is claimed is:

1. A system for messaging, comprising:
a plurality of mobile devices configured to connect to each other using a network, with each mobile device having a text input unit, with each mobile device also in communication with a multimedia object storage unit;
the multimedia storage unit storing multimedia objects and parameters associated with the multimedia objects, the parameters describing information content of each multimedia object and a user's perception of each multimedia object;
the mobile device having a text input unit and predictive text recognition unit, which analyzes the user input, including letter by letter analysis of individual words and their context, and associating the words with at least one of the parameters;
a graphic subsystem of each mobile device configured to display multimedia objects based on parameters the user input; and
each mobile device configured to enable the user of the mobile device to select at least one of the multimedia objects from a list; and
a sender's mobile device configured to send the selected multimedia object to a recipient's mobile device when the sender enters a command to send the selected multimedia object together with a text message,
wherein the parameters include tags derived from text being typed by the user, and a correspondence between the multimedia objects and the tags, including (i) the user's gender and age, (ii) gender and age of other users, and (iii) prior selections of multimedia objects by the recipient.

2. The system of claim 1, further comprising an organized database of parameters that is searchable using fuzzy criteria.

3. The system of claim 1, wherein the parameters are organized in a database of tags.

4. The system of claim 3, wherein the database is an object oriented database.

5. The system of claim 1, wherein the multimedia storage unit is located on a network data server, wherein the network data server stores parameter groups associated with multimedia objects, with at least some of the parameter groups being used by only one user.

6. The system of claim 5, wherein the user's mobile device prevents messages from being sent if the recipient's parameters indicate a de-selection of a multimedia object selected by the user.

7. The system of claim 3, wherein the mobile device enables the user to select several multimedia objects and to choose an object from the multimedia storage unit that corresponds to the majority of tags associated with objects selected previously.

8. The system of claim 1, wherein multimedia objects are selected from images, quotations, videos, musical clips and fragments of musical clips.

9. A system for messaging, comprising:
a plurality of mobile devices configured to connect to each other using a network and to connect to a server-based multimedia object storage unit;
the multimedia storage unit storing multimedia objects and parameters associated with them, the parameters describing information content of each multimedia object and a user's association of each multimedia object with a specific tag;
a predictive text recognition module on each mobile device, each module analyzing user input in voice-to-text or text form, including analysis of individual words and their context, and associating the words with at least one of the parameters;
the mobile devices configured to display a list of multimedia objects for user selection based on the parameters and the user input; and
each mobile device configured to enable the user to select at least one of the objects from a list; and
each mobile device configured to send the selected multimedia object to a recipient's mobile device when the user enters a command to send a multimedia object alongside a text message,
wherein the parameters include tags derived from text being typed by the user, and a correspondence between the multimedia objects and the tags, including (i) the user's gender and age, (ii) gender and age of other users who have selected similar multimedia objects, (iii) prior selections of multimedia objects by the recipient, and (iii) prior selections of multimedia objects by the user.

10. The system of claim 9, wherein the multimedia objects are selected prior to a connection to the recipient being completed.

11. The system of claim 9, wherein the multimedia objects are arranged into a history based on voice-to-text conversion.

12. The system of claim 9, wherein the multimedia objects include musical pieces and are selected in real time based on the user's speech patterns.

13. The system of claim 9, wherein the system corrects for tone of voice of a speaker.
